(19) United States
(12) Patent Application Publication
(10) Pub. No.: US 2010/0187961 A1
(43) Pub. Date: Jul. 29, 2010

(54) PHOSPHOR HOUSING FOR LIGHT EMITTING DIODE LAMP

(76) Inventor: Keith SCOTT, Sunnyvale, CA (US)

Correspondence Address: Arent Fox LLP, 555 West Fifth Street, 48th Floor, Los Angeles, CA, 90013, US

(21) Appl. No.: 12/360,781

(22) Filed: Jan. 27, 2009

(51) Int. Cl. H01J 61/94; H01J 1/62; H01J 9/24

(52) U.S. Cl. 313/1; 313/498; 313/502; 313/11; 445/23

(57) ABSTRACT

A light emitting apparatus includes a housing having a transparent bulb with phosphor, and at least one LED positioned within the housing to excite the phosphor and emit light through the transparent bulb.

### BACKGROUND

1. Field

The present disclosure relates to light emitting devices, and more particularly to phosphor housings for light emitting diode lamps.

2. Background

Light emitting diodes (LEDs) are attractive candidates for replacing conventional light sources such as incandescent and fluorescent lamps. LEDs have substantially higher light conversion efficiencies than incandescent lamps, and longer lifetimes than both types of conventional light sources. In addition, some types of LEDs now have higher conversion efficiencies than fluorescent light sources and still higher conversion efficiencies have been demonstrated in the laboratory. Finally, LEDs require lower voltages than fluorescent lamps, and therefore, provide various power saving benefits.

Unfortunately, LEDs produce light in a relatively narrow spectrum band. In order to provide a suitable replacement for conventional light sources, LED light sources must produce white light. A white light source may be constructed from a blue LED that is covered with a layer of phosphor. Such light sources will be referred to as “phosphor based white LEDs.” The blue light from the LED excites the phosphor at a high energy, which results in a portion of the blue light being converted to lower energy yellow light. The ratio of blue to yellow light may be chosen such that the LED light source appears to be white.

Phosphor based white LEDs present a technical challenge when used as a light source. The blue LED tends to generate a significant amount of heat. When the blue light strikes the phosphor, additional heat is generated due to stokes shift and quantum efficiency loss. The heat build up in the phosphor based white LED tends to degrade the performance of the blue LED and the phosphor, causing light output drop, color temperature shift, and shorter lifetime. Heretofore, heat sinks have been used to dissipate the heat generated by these phosphor based white LEDs.

Industry acceptance of LEDs as light sources may depend on the adaptability of these sources into existing lighting fixtures. By way of example, it would be desirable to construct an LED light source that is interchangeable with a standard light bulb so that it may be simply screwed into an existing light fixture. This may not be possible, however, if the LED light source is required to be mounted onto a heat sink. Accordingly, there is a need in the art for LED light sources with improved heat dissipation to facilitate designs that provide direct replacement for conventional light sources (e.g., incandescent and fluorescent light bulbs).

### SUMMARY

In one aspect of the disclosure, a light emitting apparatus includes a housing having a transparent bulb with phosphor, and at least one LED positioned within the housing to excite the phosphor and emit light through the transparent bulb.

In another aspect of the disclosure, light emitting apparatus includes a housing having a transparent bulb, and means, within the housing, for emitting light having a first wavelength, wherein the transparent bulb further comprises means for converting a portion of the light to a second wavelength.

In yet another aspect of the disclosure, light emitting apparatus includes at least one LED configured to emit light, and a housing containing said at least one LED, wherein the housing comprises a transparent bulb with phosphor positioned to receive at least a portion of the light emitted from said at least one LED.

In a further aspect of the disclosure, a method of fabricating a light emitting apparatus includes forming a housing having a transparent bulb with phosphor, and assembling the housing including positioning at least one LED within the housing to excite the phosphor and emit light through the transparent bulb.

It is understood that other aspects of the present invention will become readily apparent to those skilled in the art from the following detailed description, wherein it is shown and described only exemplary configurations of an LED lamp by way of illustration. As will be realized, the present invention includes other and different aspects of an LED lamp and its several details are capable of modification in various other respects, all without departing from the spirit and scope of the present invention. Accordingly, the drawings and the detailed description are to be regarded as illustrative in nature and not as restrictive.

### BRIEF DESCRIPTION OF THE FIGURES

Various aspects of the present invention are illustrated by way of example, and not by way of limitation, in the accompanying drawings, wherein:

FIG. 1 is a conceptual cross-sectional view illustrating an example of an LED;

FIG. 2A is a conceptual top view illustrating an example of an LED array;

FIG. 2B is a conceptual cross-sectional view of the LED array of FIG. 2A;

FIG. 3A is a conceptual top view illustrating an example of an encapsulated LED array;

FIG. 3B is a conceptual cross-sectional view of the encapsulated LED array of PIG. 3A;

FIG. 4A is a conceptual side view of an LED lamp with a phosphor coated housing;

FIG. 4B is a conceptual side view of an LED lamp with phosphor embedded in the housing;

FIG. 5 is a exploded side view of the LED lamp of FIG. 4A; and

FIG. 6 is a conceptual side view of another configuration of an LED lamp.

### DETAILED DESCRIPTION

The present invention is described more fully hereinafter with reference to the accompanying drawings, in which various aspects of the present invention are shown. This invention, however, may be embodied in many different forms and should not be construed as limited to the various aspects of the present invention presented throughout this disclosure. Rather, these aspects are provided so that this disclosure will be thorough and complete, and will filly convey the scope of the present invention to those skilled in the art. The various aspects of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method.

Various aspects of the present invention will be described herein with reference to drawings that are schematic illustrations of idealized configurations of the present invention. As such, variations from the shapes of the illustrations as a result, for example, manufacturing techniques and/or tolerances, are to be expected. Thus, the various aspects of the present invention presented throughout this disclosure should not be construed as limited to the particular shapes of elements (e.g., regions, layers, sections, substrates, bulb shapes, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present invention.

It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. It will be further understood that when an element is referred to as being “formed” on another element, it can be grown, deposited, etched, attached, connected, coupled, or otherwise prepared or fabricated on the other element or an intervening element.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements described as being on the “lower” side of other elements would then be oriented on the “upper” side of the other elements. The term “lower”, can therefore, encompass both an orientation of “lower” and “upper,” depending of the particular orientation of the apparatus. Similarly, if an apparatus in the drawing is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Various aspects of an LED lamp with a phosphor housing will now be presented. However, as those skilled in the art will readily appreciate, these aspects may be extended to other light sources without departing from the scope of the invention. The LED lamp may be configured as a direct replacement for conventional light sources, including, by way of example, incandescent, fluorescent, halogen, quartz, high-density discharge (HID), and neon lamps or bulbs. The LED is well known in the art and therefore, will only briefly be discussed to provide a complete description of the invention.

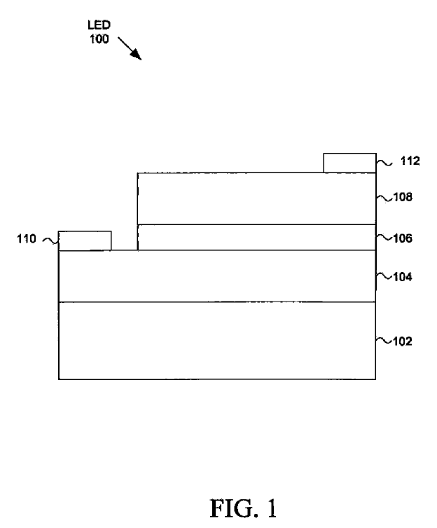

FIG. 1 is a conceptual cross-sectional view illustrating an example of an LED. An LED is a semiconductor material impregnated, or doped, with impurities. These impurities add “electrons” and “holes” to the semiconductor, which can move in the material relatively freely. Depending on the kind of impurity, a doped region of the semiconductor can have predominantly electrons or holes, and is referred respectively as N-type or P-type semiconductor regions. Referring to FIG. 1, the LED 100 includes an N-type semiconductor region 104 and a P-type semiconductor region 108. A reverse electric field is created at the junction between the two regions, which cause the electrons and holes to move away from the junction to form an active region 106. When a forward voltage sufficient to overcome the reverse electric field is applied across the PN junction through a pair of electrodes 110, 112, electrons and holes are forced into the active region 106 and recombine. When electrons recombine with holes, they fall to lower energy levels and release energy in the form of light.

In this example, the N-type semiconductor region 104 is formed on a substrate 102 and the P-type semiconductor region 108 is formed on the active layer 106, however, the regions may be reversed. That is, the P-type semiconductor region 108 may be formed on the substrate 102 and the N-type semiconductor region 104 may formed on the active layer 106. As those skilled in the art will readily appreciate, the various concepts described throughout this disclosure may be extended to any suitable layered structure. Additional layers or regions (not shown) may also be included in the LED 100, including but not limited to buffer, nucleation, contact and current spreading layers or regions, as well as light extraction layers.

The P-type semiconductor region 108 is exposed at the top surface, and therefore, the P-type electrode 112 may be readily formed thereon. However, the N-type semiconductor region 104 is buried beneath the N-type semiconductor layer 108 and the active layer 106. Accordingly, to form the N-type electrode 110 on the N-type semiconductor region 104, a cutout area or “mesa” is formed by removing a portion of the active layer 106 and the P-type semiconductor region 108 by means well known in the art to expose the N-type semiconductor layer 104 therebeneath. After this portion is removed, the N-type electrode 110 may be formed.

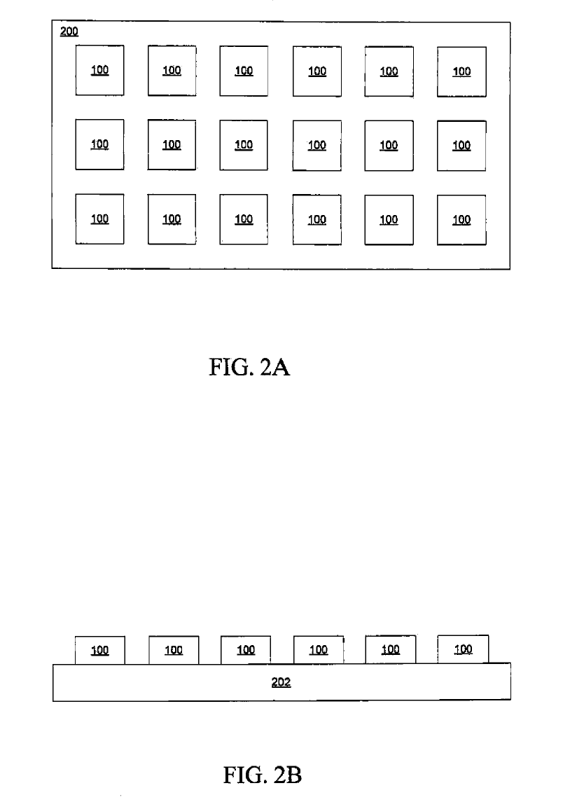

In a configuration of an LED lamp, an LED array 200 may be used to provide increased light output FIG. 2A is a conceptual top view illustrating an example of an LED array 200, and FIG. 2B is a conceptual cross-sectional view of the LED array 200 of FIG. 2A. In this example, a number of LEDs 100 may be formed on a substrate 202 by means well known in the art. The bond wires (not shown) extending from the LEDs 100 may be connected to traces (not shown) on the surface of the substrate 202, which connect the LEDs 100 in a parallel and/or series fashion. Typically, the LEDs 100 may be connected in parallel streams of series LEDs with a current limiting resistor (not shown) in each stream. The substrate 102 may be any suitable material that can provide support to the LEDs 100 and can be mounted within a housing (not shown).

Optionally, the LED array 200 may be encapsulated in an epoxy, silicone, or other thermally-conductive transparent encapsulation material. The encapsulation material may be used to focus the light emitted from the LEDs 100, as well as protect the LEDs 100 from the elements. By encapsulating the LEDs 100, the LED array 200 becomes extremely durable with no loose or moving parts. As a result, the LED array 200 becomes essentially an array of PN junction semiconductor diodes that emit light when a forward voltage is applied, resulting in a very reliable device.

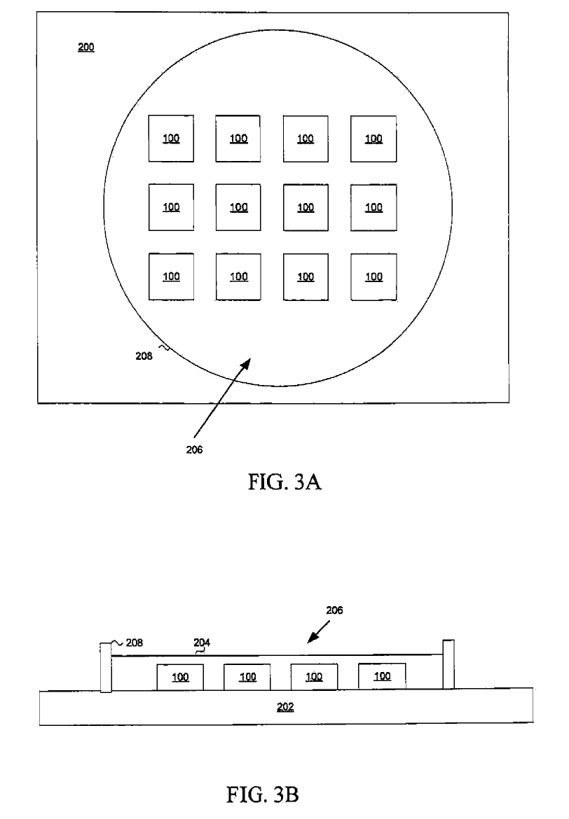

Turning to FIGS. 3A and 3B, encapsulation material 204 may be deposited within a cavity 206 bounded by an annular ring 208 that extends circumferentially around the outer surface of the substrate 202. The annular ring 208 may be formed separately from the substrate 202 and attached to the substrate using adhesive or other means. Alternatively, the substrate 202 and the annular ring 208 may be formed with a suitable mold or the annular ring 208 may be formed by boring a cylindrical hole in a material that forms the substrate 202.

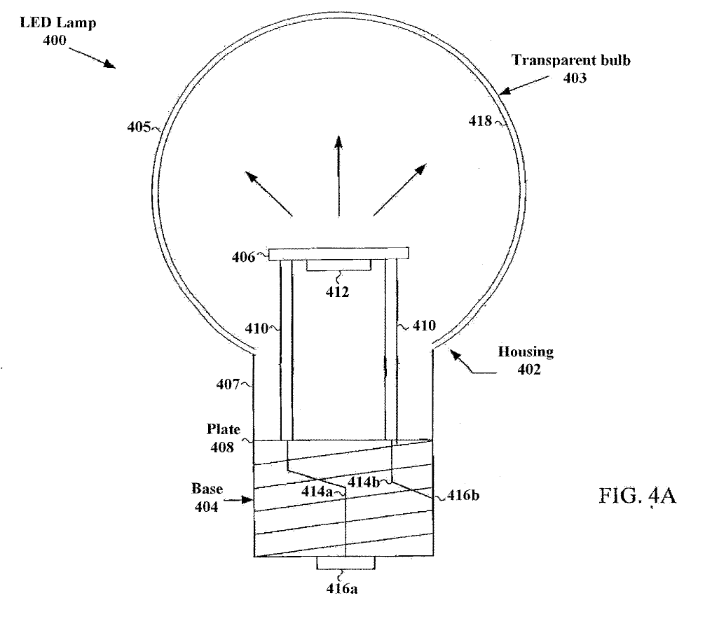

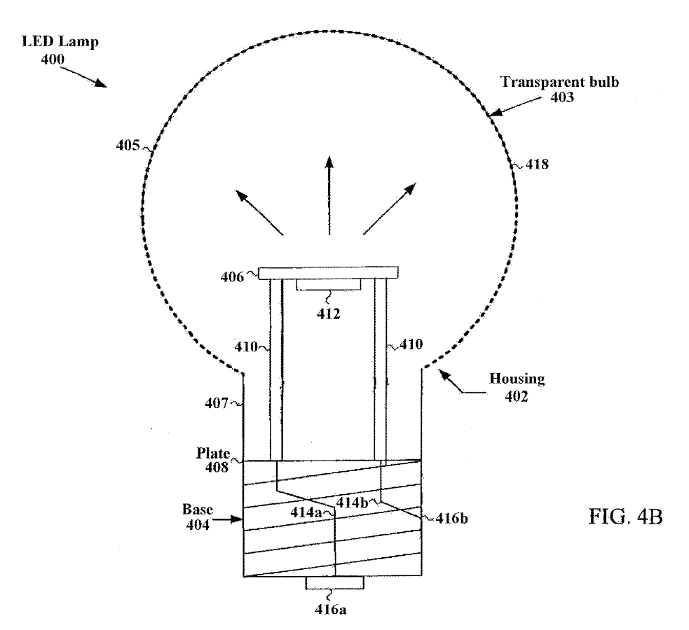

Turning to FIGS. 4A and 4B, an LED lamp 400 may include a housing 402 having a transparent bulb 403 (e.g., glass, plastic, etc.) mounted onto a base 404. The bulb 403 is shown with a substantially circular portion 405 extending from a neck portion 407, although the bulb 403 may take on other shapes and forms depending on the particular application. An LED array 406 positioned within the housing 402 may be used as a light source. The LED array 406 may take on various forms, including the configurations discussed earlier in connection with FIGS. 2A, 2B, 3A and 3B, or any other suitable configuration now known or developed in the future. Although an LED array is well suited for the LED lamp, those skilled in the art will readily understand that the various concepts presented throughout this disclosure are not necessarily limited to an LED array and may be extended to an LED lamp with a single LED.

A plate 408 anchored to the base 404 provides support for the LED array 406. In one configuration of an LED lamp 400, standoffs 410 extending from the plate 408 are used to separate the LED array 406 from the plate 408. Examples include plastic standoffs with conical heads that can be pushed through holes in the substrate of the LED array 406 or hollow plastic standoffs with internal threads that allow the LED array 406 to be mounted with screws. Other ways to mount the LED array 406 will be readily apparent to those skilled in the art from the teachings presented throughout this disclosure. The plate 408 may be constructed from any suitable insulting material, including by way of example, glass.

A fan 412 may be used to cool the LED array 406. A non-limiting example of a fan that is well suited for LED lamp applications is an RSD5 solid-state fan developed by Thorm Micro Technologies, Inc. The RSD5 uses a series of live wires that produce an ion rich gas with free electrons for conducting electricity. The wires lie within uncharged conducting plates that are contoured into half-cylindrical shapes to partially envelope the wires. Within the electric field that results, the ions push neutral air molecules from the wire to the plate, generating air flow. The fan 412 may be mounted to the substrate of the LED array 406 as shown in FIG. 4, but may be mounted elsewhere in the housing 402. Those skilled in the art will be readily able to determine the location of the fan 412 best suited for any particular application based on the overall design parameters.

The plate 408 also provides a means for routing wires 414a and 414b from the LED array 406 to electrical contacts 416a and 416b on the base 404. In one configuration of an LED lamp 400, the wires 414a and 414b may be routed from the LED array 406 to the plate 412 through the plastic hollow standoffs previously described. In another configuration of an LED lamp 400, the wires 414a and 414b themselves can be used to separate the LED array 404 from the plate 408, thus eliminating the need for standoff. In the latter configuration, the wires 414a and 414b may be spot welded to feedthrough holes in the plate 408 with another set of spot welded wires extending from the feedthrough holes to the electrical contacts 416a and 416b on the base 404.

The arrangement of electrical contacts 416a and 416b may vary depending on the particular application. By way of example, the LED lamp 400 may have a base 404 with a screw cap configuration, as shown in FIGS. 4A and 4B, with one electrical contact 416a at the tip of the base 404 and the screw cap serving as the other electrical contact 416b. Contacts in the lamp socket (not shown) allow electrical current to pass through the base 404 to the LED array 406. Alternatively, the base may have a bayonet cap with the cap used as an electrical contact or only as a mechanical support. Some miniature lamps may have a wedge base and wire contacts, and some automotive and special purpose lamps may include screw terminals for connection to wires. The arrangement of electrical contacts for any particular application will depend on the design parameters of that application.

Power may be applied to the LED array 406 and the fan 412 Through the electrical contacts 416a and 416b. An AC-DC converter (not shown) may be used to generate a DC voltage from a lamp socket connected to a wall-plug in a household, office building, or other facility. The DC voltage generated by the AC-DC converter may be provided to a driver circuit (not shown) configured to drive both the LED array 406 and the fan 412. The AC-DC converter and the driver circuit may be located in the base 404, on the LED array 406, or anywhere else in the housing 402. In some applications, the AC-DC converter may not be needed. By way of example, the LED array 406 and the fan 412 may be designed for AC power. Alternatively, the power source may be DC, such as the case might be in automotive applications. The particular design of the power delivery circuit for any particular application is well within the capabilities of one skilled in the art.

The bulb 403 may include phosphor 418. The phosphor 418 may be formed on the inner surface of bulb 403 as shown in FIG. 4A, or alternatively, the phosphor 418 maybe embedded in the bulb 403 as shown in FIG. 4B. As described earlier, the phosphor 418 absorbs high energy light emitted by the LED array 406 and converts it to a low energy light having a different wavelength. A white LED light source can be constructed by using an LED array 406 that emits light in the blue region of the spectrum. The blue light excites the phosphor 418 at a high energy and the phosphor 418 converts it to lower energy yellow light. A white light source is well suited as a replacement lamp for conventional light sources; however, the invention may be practiced with other LED and phosphor combinations to produce different color lights.

By providing a bulb 403 with phosphor 418, the heat generated in the LED array 406 is reduced, and as a result, the LED array 406 outputs more light with improved reliability and longer lifetime. In addition, the heat generated by the phosphor 418 is widely distributed over the housing 402, and therefore, the phosphor 418 will experience less degradation, less color shift, better stability, and more light output. Finally, the light resulting from phosphor scattering that would otherwise be absorbed by the LED array 406 if it were completely encapsulated by the phosphor is no longer an issue, resulting in increased light output.

Various examples of a process for forming phosphor on a bulb as shown in FIG. 4A will now be presented. However, as those skilled in the art will readily appreciate, the inventive concepts described throughout this disclosure are not limited to such processes. In these examples, the process begins with a sheet of transparent material such as silica. The transparent material is heated in a furnace and a ribbon of glass is then cut from the material. The glass ribbon is placed in a bulb-shaped mold and allowed to harden. Once hardened, the glass ribbon is removed from the mold, and as a result, takes on the shape of a bulb. By way of example, a glass ribbon may be molded in the shape of the bulb 403 in FIG. 4A, or molded into some other suitable shape. Once the glass ribbon is molded into the appropriate shape, phosphor may be applied.

One example of a process for applying phosphor to the bulb will now be presented. In this example, the phosphor is mixed with a binder. Alternatively, a binder may be applied to the inner surface of the bulb 403. Next, the phosphor is introduced into the bulb 403. By way of example, in the bulb 403 configuration shown in FIG. 4A, the bulb 403 may turned upside down and filled with the phosphor. In this example, the phosphor that does not adhere to the inner surface of the bulb 403 may be dispensed by simply turning the bulb 403 right side up. This process may be repeated as many times as necessary to achieve the desired amount of phosphor. Next, the bulb may be heated in a furnace to further bind the phosphor to the glass and to drive out any impurities in the phosphor. The bulb 403 is then cooled and hardened.

Another example of a process for applying phosphor to a bulb involves electro-deposition. In this example, the phosphor is deposited onto a plate. The plate and the bulb are then connected to a DC power supply or battery with the plate being connected to the positive terminal and the bulb being connected to the negative terminal. Both the plate and bulb may be immersed in an electrolyte solution. When power is applied, the metal molecules in the phosphor oxidize and are dissolved in the solution. At the bulb, the metal molecules dissolved in the electrolyte solution are reduced at the interface between the solution and the bulb such that they plate out onto the bulb. This process may be repeated as many times as necessary to achieve the desired amount of phosphor. As with the previous example, a binder may be mixed with the phosphor, or alternatively, a binder may be applied to the inner surface of the bulb.

A further example of a process for applying phosphor to a bulb 403 involves vapor deposition. In this example, a thin film of phosphor is deposited on the inner surface of the bulb 403 by the condensation of vaporized phosphor onto the glass. More specifically, the process is performed by vaporizing the phosphor and then filling the bulb 403 with the vaporized gas. Similar to the previous examples, the phosphor may be mixed with a binder, or the binder can be applied to the inner surface of the bulb. The gas is then cooled resulting in a layer of solidified phosphor on the inner surface of the bulb. This process may be repeated as many times as necessary to achieve the desired amount of phosphor.

As an alternative to forming the phosphor on the bulb, the phosphor may be embedded in the bulb as shown in FIG. 4B. By way of example, phosphor may be mixed with silica before it is made into a transparent sheet from which the ribbon of glass or bulb is cut.

The various methods presented thus far for forming a bulb with phosphor are non-limiting examples intended to enable those skilled in the art to practice the full scope of the invention. It will be understood that other methods may be used without departing from the spirit and scope of the invention.

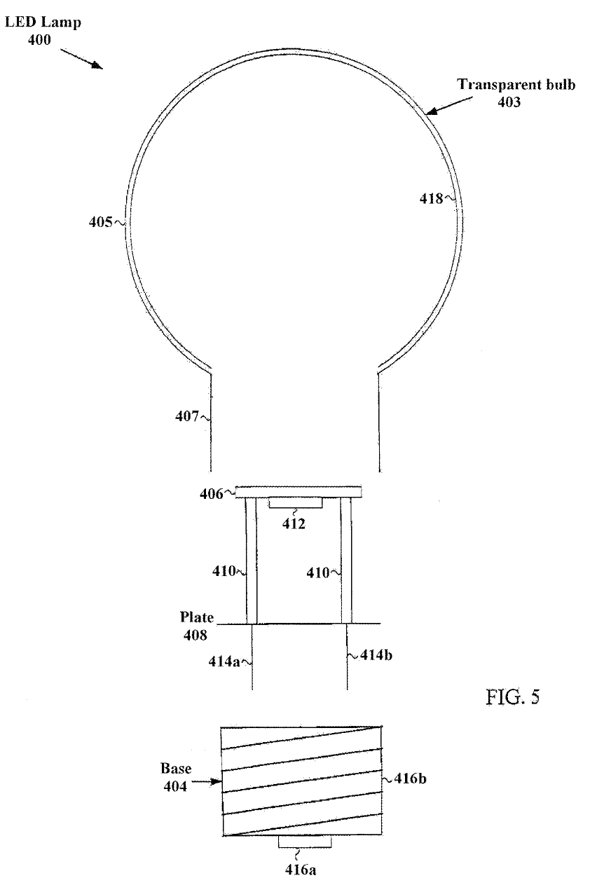

FIG. 5 is an exploded side view of the LED lamp 400 of FIG. 4A showing the individual dissembled elements of the LED lamp 400 in their proper relationship with respect to their assembled position. In this example, the disassembled elements include the bulb 403, the plate 408, and the base 404.

The LED lamp 400 may be assembled by mounting the LED array 406 and the fan 412 onto the plate 408 using standoffs 410 or some other suitable means. Once the LED array 406 and the fan 412 are mounted to the plate 408, the plate may be attached to the neck 407 of the bulb 403. In the case where the plate 408 is glass, the bulb 403 may be fused to the plate 408. The electrical wires 414a and 414b extending from the plate 408 may be connected to the electrical contacts 416a and 416b, respectively, and then the bulb 403 may be mounted to the base 404.

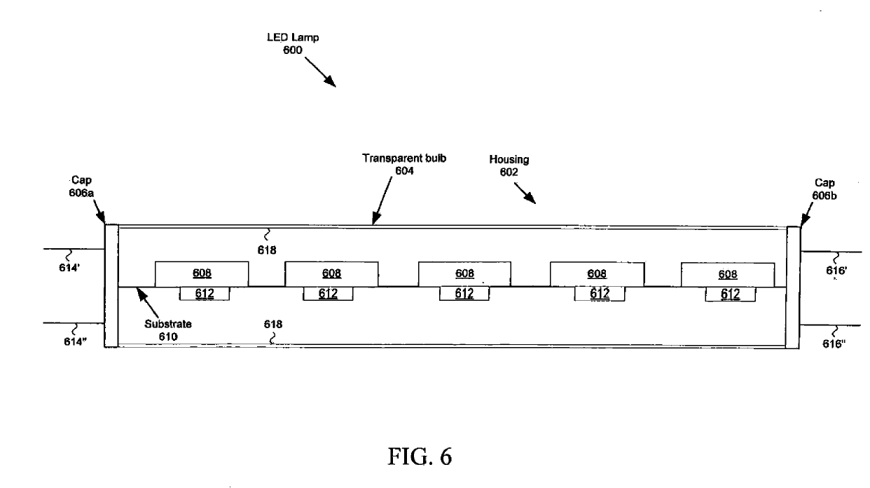

FIG. 6 is a conceptual side view of another configuration of an LED lamp. In this configuration, a housing 602 includes a transparent bulb 604 in the shape of a tube with caps 606a and 606b at the ends. A number of LED arrays 608 may be distributed along a substrate 610 that extends across the tubular bulb 604. Alternatively, the substrate 610 may support a single LED array, or even a single LED. The various configurations of LEDs and LED arrays presented thus far are well suited for this LED lamp application, but other configurations may also be used. A phosphor 618 may be applied to the inner surface of the tubular bulb 604. Alternatively, the phosphor may be embedded in the tubular bulb. A number of RSD5 fans 612, or other cooling devices, may also be distributed along the substrate 610, or located elsewhere, to cool the LED arrays 608. Two electrical contacts 614′ and 614″ extend from one cap 606a and two electrical contacts 616′ and 616″ extend from the other cap 606b. The electrical contact arrangement allows the LED lamp to function as a direct replacement for conventional fluorescent lamps.

Power may be applied between to the LED arrays 608 and the fans 612 through any pair of electrical contacts. By way of example, one of the electrical contacts 614′ on one cap 606a may be connected to a voltage source and one of the electrical contacts 616′ on the other cap 606b may be connected to the voltage return. In higher current applications, the voltage source may be connected to both electrical contacts 614′ and 614″ extending from one cap 606a and the voltage return may be connected to both electrical contacts 616′ and 616″ extending from the other cap 606b. An AC-DC converter (not shown) and driver (not shown) may be used to generate a DC voltage and drive the LED arrays 608 and fans 612. The AC-DC converter and driver may be mounted onto the substrate 610 or located elsewhere in the LED lamp 600. Alternatively, the AC-DC converter and/or driver may be mounted outside the lamp, either inside or outside of the light fixture.

The various aspects of his disclosure are provided to enable one of ordinary skill in the art to practice the present invention Various modifications to aspects presented throughout this disclosure will be readily apparent to those skilled in the art, and the concepts disclosed herein may be extended to other LED lamp configurations regardless of the shape or diameter of the glass enclosure and the base and the arrangement of electrical contacts on the lamp. By way of example, these concepts may be applied to bulb shapes commonly referred to in the art as A series, B series, C-7/F series, ER, G series, GT, K, P-25/PS-35 series, BR series, MR series, AR series, R series, RP-11/S series, PAR Series, Linear series, and T series; ED17, ET, ET-18, ET23.5, E-25, BT-28, BT-37, BT-56. These concepts may also be applied to base sizes commonly referred to in the art as miniature candela screw base E10 and E11, candela screw base E12, intermediate candela screw base E17, medium screw base E26, E26D, E27 and E27D, mogul screw base E39, mogul Pf P40s, medium skirt E26/50×39, candela DC bay, candela SC bay B15, BA15D, BA15S, D. C. Bayonet, 2-lug sleeve B22d, 3-lug sleeve B22-3, medium Pf P28s, mogul bi-post G38, base RSC, screw terminal, disc base, single contact, medium bi-post, mogul end prong, spade connector, mogul pre-focus and external mogul end prong; admedium skirted, medium skirted, position-oriented mogul, BY 22 D, Fc2, ceramic spade series (J, G, R), RRSC, RSC; single pin series, bi-pin series, G, GX, 2G series. Thus, the claims are not intended to be limited to the various aspects of his disclosure, but are to be accorded the full scope consistent with the language of the claims. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A light emitting apparatus, comprising:
a housing having a transparent bulb with phosphor; and
at least one LED positioned within the housing to excite the phosphor and emit light through the transparent bulb.

2. The light emitting apparatus of claim 1 wherein the phosphor is formed on at least a portion of a surface of the transparent bulb.

3. The light emitting apparatus of claim 1 wherein the phosphor is embedded in at least a portion of the transparent bulb.

4. The light emitting apparatus of claim 1 further comprising a fan positioned with the housing to cool said at least one LED.

5. The light emitting apparatus of claim 1 wherein said at least one LED comprises an array of LEDs.

6. The light emitting apparatus of claim 1 wherein the housing further comprises a base configured to electrically and mechanically mate with a lamp socket.

7. The light emitting apparatus of claim 6 wherein the transparent bulb extends from the base, wherein the transparent bulb has a maximum diameter that is greater than a diameter of the base.

8. The light emitting apparatus of claim 6 wherein the transparent bulb comprises a neck portion extending from the base and a substantially spherical portion extending from the neck portion.

9. The light emitting apparatus of claim 6 wherein the base comprises electrical contacts coupled to said at least one LED.

10. The light emitting apparatus of claim 9 wherein the base comprises a cap configured to mechanically mate with the lamp socket, the cap comprising one of the electrical contacts.

11. The light emitting apparatus of claim 10 wherein the base further comprises a tip having another one of the electrical contacts.

12. The light emitting apparatus of claim 6 wherein the base comprises a screw cap configured to mechanically mate with the lamp socket.

13. The light emitting apparatus of claim 1 further comprising a base and a plate between the base and the transparent bulb, wherein said at least one LED is supported by the plate.

14. The light emitting apparatus of claim 13 wherein the base comprises electrical contacts, and wherein the plate provides a feedthrough for coupling the electrical contacts to said at least one LED.

15. The light emitting apparatus of claim of claim 14 wherein said at least one LED is supported by the plate by a plurality of hollow standoffs, and wherein said at least one LED includes wires for coupling to the electrical contacts, each of at least one of the wires being routed through one of the standoffs.

16. The light emitting apparatus of claim 14 wherein said at least one LED includes wires for coupling to the electrical contacts, and wherein said at least one LED is supported by the plate by at least one of the wires.

17. The light emitting apparatus of claim 1 wherein the housing further comprises two caps, each of the two caps having at least one electrical contact, and wherein the transparent bulb comprises a tubular shape extending between the two caps.

18. A light emitting apparatus, comprising:
a housing having a transparent bulb; and
means, within the housing, for emitting light having a first wavelength;
wherein the transparent bulb further comprises means for converting a portion of the light to a second wavelength.

19. The light emitting apparatus of claim 18 wherein the means for converting a portion of the light to a second wavelength comprises phosphor.

20. The light emitting apparatus of claim 19 wherein the phosphor is formed on at least a portion of a surface of the transparent bulb.

21. The light emitting apparatus of claim 19 wherein the phosphor is embedded in at least a portion of the transparent bulb.

22. The light emitting apparatus of claim 18 further comprising means, positioned within the housing, to cool the light emitting means.

23. The light emitting apparatus of claim 18 wherein the light emitting means comprises at least one LED.

24. The light emitting apparatus of claim 23 wherein said at one LED comprises an array of LEDs.

25. The light emitting apparatus of claim 18 wherein the housing further comprises means for electrically and mechanically mating with a lamp socket.

26. The light emitting apparatus of claim 25 wherein the transparent bulb extends from the means for electrically and mechanically mating with a lamp socket, wherein the transparent bulb has a maximum diameter that is greater than a diameter of the means for electrically and mechanically mating with a lamp socket.

27. The light emitting apparatus of claim 25 wherein the transparent bulb comprises a neck portion extending from the means for electrically and mechanically mating with a lamp socket, and a substantially spherical portion extending from the neck portion.

28. The light emitting apparatus of claim 25 wherein the means for electrically and mechanically mating with a lamp socket comprises electrical contacts coupled to said at least one LED.

29. The light emitting apparatus of claim 28 wherein the means for electrically and mechanically mating with a lamp socket comprises a cap configured to mechanically mate with the lamp socket, the cap comprising one of the electrical contacts.

30. The light emitting apparatus of claim 29 wherein the means for electrically and mechanically mating with a lamp socket further comprises a tip having another one of the electrical contacts.

31. The light emitting apparatus of claim 25 wherein the means for electrically and mechanically mating with a lamp socket comprises a screw cap configured to mechanically mate with the lamp socket.

32. The light emitting apparatus of claim 25 wherein the means for electrically and mechanically mating with a lamp socket comprises two caps, each of the two caps having at least one electrical contact, and wherein the transparent bulb comprises a tubular shape extending between the two caps.

33. The light emitting apparatus of claim 18 further comprising means for supporting said at least one LED.

34. A light emitting apparatus, comprising:
at least one LED configured to emit light; and
a housing containing said at least one LED, wherein the housing comprises a transparent bulb with phosphor positioned to receive at least a portion of the light emitted from said at least one LED.

35. The light emitting apparatus of claim 34 wherein the phosphor is formed on at least a portion of a surface of the transparent bulb.

36. The light emitting apparatus of claim 34 wherein the phosphor is embedded in at least a portion of the transparent bulb.

37. The light emitting apparatus of claim 34 further comprising a fan positioned within the housing to cool said at least one LED.

38. The light emitting apparatus of claim 34 wherein said at least one LED comprises an array of LEDs.

39. The light emitting apparatus of claim 34 wherein the housing further comprises a base configured to electrically and mechanically mate with a lamp socket.

40. The light emitting apparatus of claim 39 wherein the transparent bulb extends from the base, wherein the transparent bulb has a maximum diameter that is greater than a diameter of the base.

41. The light emitting apparatus of claim 39 wherein the transparent bulb comprises a neck portion extending from the base and a substantially spherical portion extending from the neck portion.

42. The light emitting apparatus of claim 39 wherein the base comprises electrical contacts coupled to said at least one LED.

43. The light emitting apparatus of claim 42 wherein the base comprises a cap configured to mechanically mate with the lamp socket, the cap comprising one of the electrical contacts.

44. The light emitting apparatus of claim 43 wherein the base further comprises a tip having another one of the electrical contacts.

45. The light emitting apparatus of claim 39 wherein the base comprises a screw cap configured to mechanically mate with the lamp socket.

46. The light emitting apparatus of claim 34 further comprising a base and a plate between the base and the transparent bulb, wherein said at least one LED is supported by the plate.

47. The light emitting apparatus of claim 46 wherein the base comprises electrical contacts, and wherein the plate provides a feedthrough for coupling the electrical contacts to said at least one LED.

48. The light emitting apparatus of claim of claim 47 wherein said at least one LED is supported by the plate by a plurality of hollow standoffs, and wherein said at least one LED includes wires for coupling to the electrical contacts, each of at least one of the wires being routed through one of the standoffs.

49. The light emitting apparatus of claim 47 wherein said at least one LED includes wires for coupling to the electrical contacts, and wherein said at least one LED is supported by the plate by at least one of the wires.

50. The light emitting apparatus of claim 34 wherein the housing further comprises two caps, each of the two caps having at least one electrical contact, and wherein the transparent bulb comprises a tubular shape extending between the two caps.

51. A method of fabricating a light emitting apparatus, comprising:
forming a housing having a transparent bulb with phosphor; and
assembling the housing including positioning at least one LED within the housing to excite the phosphor and emit light through the transparent bulb.

52. The method of claim 51 wherein the housing is formed by applying the phosphor on at least a portion of the surface of the transparent bulb.

53. The method of claim 52 wherein the phosphor is applied to the transparent bulb by introducing the phosphor into the transparent bulb and then dispensing from the transparent bulb the portion of the phosphor that does not adhere to the transparent bulb.

54. The method of claim 52 wherein the phosphor is applied to the transparent bulb by electrodeposition.

55. The method of claim 52 wherein the phosphor is applied to the transparent bulb by vapor deposition.

56. The method of claim 51 wherein the housing is formed by embedding phosphor in at least a portion of the transparent bulb.

57. The method of claim 51 wherein the assembly of the housing includes positioning a fan within the housing to cool said at least one LED.

58. The method of claim 51 wherein the assembly of the housing includes attaching a base to the transparent bulb, the base being configured to electrically and mechanically mate with a lamp socket.

59. The method of claim 58 wherein the assembly of the housing further includes providing a plate within the housing and mounting said at least one LED to the plate.

60. The method of claim 59 wherein the assembly of the housing further includes mounting a fan between said at least one LED and the plate.

61. The method of claim 60 wherein the assembly of the housing further comprises routing wires from said at least one LED to the electrical contacts though a feedthrough in the plate.

62. The method of claim 61 wherein the assembly of the housing further includes routing the wires such that said at least one LED is supported away from the plate by at least one of the wires.

63. The method of claim 61 wherein the assembly of the housing further includes supporting said at least one LED away from the plate with hollow standoffs and routing each of the wires through one of the standoffs.

64. The method of claim 51 wherein the assembly of the housing includes attaching one cap to each end of the transparent bulb, each of the two caps having at least one electrical contact and wherein the transparent bulb comprises a tubular shape extending between the two caps.
